(19) United States
(12) Patent Application Publication
(10) Pub. No.: US 2024/0211906 A1
(43) Pub. Date: Jun. 27, 2024

(54) AUTOMATED DETECTION AND PROCESSING OF PREAUTHORIZED RECURRING TRANSACTIONS

(71) Applicant: Capital One Services, LLC, McLean, VA (US)

(72) Inventors: Allison Fenichel, Brooklyn, NY (US); Amanda Sneider, New York, NY (US)

(73) Assignee: Capital One Services, LLC, McLean, VA (US)

(21) Appl. No.: 18/086,836

(22) Filed: Dec. 22, 2022

(51) Int. Cl. G06Q 20/10; G06N 20/00; G06Q 20/38; G06Q 20/40

(52) U.S. Cl. CPC G06Q 20/102; G06N 20/00; G06Q 20/389; G06Q 20/4018; G06Q 20/405; G06Q 20/407

(57) ABSTRACT

Systems, methods, and apparatuses for automatically detecting and authorizing recurring transactions are described. Transaction data comprising transaction details for an incoming charge associated with a merchant may be received. Based on the merchant being included in a blocked merchants list, determining that authorization of incoming charges for preauthorized recurring transactions associated with the merchant are blocked. Based on a machine learning model and the transaction data, a probability that the incoming charge for the merchant is a preauthorized recurring transaction may be determined. The machine learning model may be configured to identify preauthorized recurring transactions based on the transaction data. Furthermore, based on the probability not exceeding a threshold probability, the authorization of the incoming charge may be prevented from being blocked.

### FIELD OF USE

Aspects of this disclosure relate to computer implemented systems and methods for regulating the blockage of certain types of transactions. More specifically, aspects of the disclosure provide for automatically preventing the blockage of specific types of electronic transactions based on the use of a machine learning model that is configured to determine the probability that an associated incoming charge is a preauthorized recurring transaction.

### BACKGROUND

The popularity of subscription services has risen in recent years. Furthermore, traditional types of subscription services that were popular in the past (e.g., newspaper and magazine subscriptions) have been joined and in some cases supplanted by newer types of subscription services. These newer types of subscription services include variations of older types of services as well as entirely new services some of which are electronic in nature (e.g., video streaming services and online gaming services). Further, the ways in which these services may be acquired and cancelled have changed over time. For example, many subscription services may be activated or cancelled online with the click of a button. The ease with which these services may be added may also contribute to an increase in situations in which a consumer loses track of the services to which that consumer is subscribed.

As a result, consumers may end up inadvertently spending significant amounts of money in the form of unwanted subscription charges that are withdrawn from consumers accounts on an ongoing basis. To deal with such unwanted services, a consumer may take the steps of canceling the service and to further ensure that no additional charges occur may also block payments to the merchant that provided the canceled service. However, blocking the merchants that provide cancelled services may also result in the blockage of other services or goods that the merchant provides and which the consumer would still wish to purchase. As a result, some consumers may end up spending a considerable amount of time and resources to manually review goods and services to identify the goods and services that should not have been blocked.

### SUMMARY

The following presents a simplified summary of various aspects described herein. This summary is not an extensive overview, and is not intended to identify key or critical elements or to delineate the scope of the claims. The following summary merely presents some concepts in a simplified form as an introductory prelude to the more detailed description provided below.

Aspects described herein may address these and other problems, and generally improve the effectiveness with which incoming charges that are not preauthorized recurring transactions may be processed.

Aspects described herein may allow for automatic methods, systems, and apparatuses to detect incoming charges associated with a blocked merchant, use a machine learning model to determine whether the incoming charge is a preauthorized recurring transaction, and prevent the blockage of incoming charges that are not preauthorized recurring transactions. The use of the disclosed technology may have the effect of conserving computing resources by reducing the wastage of computing resources that results from the intake and resolution of requests associated with reversing improperly blocked charges. Furthermore, by proactively determining incoming charges that are less likely to be preauthorized recurring charges, the disclosed technology may facilitate the expeditious processing and authorization of incoming charges that are associated with improperly blocked merchants.

More particularly, some aspects described herein may provide a computer-implemented method that comprises receiving transaction data comprising transaction details for an incoming charge associated with a merchant. The computer-implemented method may comprise determining, based on the merchant being included in a blocked merchants list, that authorization of incoming charges for preauthorized recurring transactions associated with the merchant are blocked. Further, the computer-implemented method may comprise determining, based on a machine learning model and the transaction data, a probability that the incoming charge for the merchant is a preauthorized recurring transaction. The machine learning model may be configured to identify preauthorized recurring transactions based on the transaction data. Furthermore, the computer-implemented method may comprise preventing, based on the probability not exceeding a threshold probability, the authorization of the incoming charge from being blocked.

According to some aspects described herein, the transaction data may comprise a card verification value (CVV) field and the machine learning model may be further configured to perform steps comprising determining, based on the CVV field, that the probability of the incoming charge being based on a preauthorized recurring transaction is negatively correlated with the CVV field indicating that the incoming charge is based on a card present transaction.

According to some aspects described herein, the transaction data may comprise a payment mechanism field and the machine learning model may be further configured to perform steps comprising determining, based on the payment mechanism field, that the probability of the incoming charge being based on a preauthorized recurring transaction is negatively correlated with the payment mechanism field indicating that the incoming charge is based on a card transaction using a card reader device or a mobile wallet transaction using a mobile device and a contactless point of sale system.

According to some aspects described herein, the transaction data may comprise a merchant category code field and the machine learning model may be further configured to perform steps comprising determining, based on the merchant category code field, that the probability of the incoming charge being based on a preauthorized recurring transaction is positively correlated with the merchant category code field indicating that a category of goods or services provided by the merchant correspond to a preauthorized recurring transaction.

According to some aspects described herein, the transaction data may comprise a recurring transaction field and the machine learning model may be further configured to perform steps comprising determining, based on the recurring transaction field, that the probability of the incoming charge being based on a preauthorized recurring transaction is positively correlated with the recurring transaction field indicating that the incoming charge is a preauthorized recurring transaction.

According to some aspects described herein, the transaction data may comprise a transaction description field and the machine learning model may be further configured to perform steps comprising determining, based on the transaction description field, that the probability of the incoming charge being based on a preauthorized recurring transaction is positively correlated with one or more key words describing the incoming charge as a preauthorized recurring transaction.

According to some aspects described herein, the transaction data may comprise an amount of the incoming charge and the machine learning model may be further configured to perform steps comprising determining that the probability of the incoming charge being based on a preauthorized recurring transaction is positively correlated with an amount of the transaction matching a subscription cost of the merchant.

According to some aspects described herein, the computer-implemented method may further comprise training the machine learning model based on steps comprising: inputting historical transaction data into the machine learning model, wherein the historical transaction data comprises historical incoming charges of a plurality of merchants; generating, based on the machine learning model and the historical transaction data, output comprising predicted probabilities that the historical incoming charges are preauthorized recurring transactions; and adjusting a weighting of parameters of the machine learning model based on an accuracy of the predicted probabilities.

According to some aspects described herein, the historical transaction data may comprise at least one of an amount of time between historical preauthorized recurring transactions, one or more dates on which the historical preauthorized recurring transactions were posted, or one or more monetary amounts of the historical preauthorized recurring transaction.

According to some aspects described herein, the historical incoming charges may be associated with ground truth labels indicating whether each of the historical incoming charges is either a preauthorized recurring transaction or not a preauthorized recurring transaction, and wherein the accuracy of the predicted probabilities is based on an extent to which the predicted probabilities correspond to the ground truth labels.

According to some aspects described herein, the one or more fields of the historical transaction data may comprise a merchant category code field, a recurring transaction field, or a transaction description field.

According to some aspects described herein, the preauthorized recurring transactions may comprise online service subscriptions, product delivery subscriptions, or news media subscriptions.

According to some aspects described herein, the computer-implemented method may further comprise receiving user feedback with respect to accuracy with which the machine learning model identifies preauthorized recurring transactions; and adjusting the threshold probability based on the user feedback.

According to some aspects described herein, the computer-implemented method may further comprise, based on the probability not exceeding a threshold probability, sending a notification to a user, wherein the notification indicates that authorization of the incoming charge is not being blocked.

According to some aspects described herein, the computer-implemented method may further comprise, based on the probability not exceeding a threshold probability, updating the transaction data to indicate that the incoming charge is not a preauthorized recurring transaction.

According to some aspects described herein, the computer-implemented method may further comprise scraping one or more websites associated with the merchant for one or more key words associated with preauthorized recurring transactions; and training, based on the one or more key words, the machine learning model. Further, determining the one or more websites to scrape may be based on a browser extension configured to detect the one or more key words. Further, the content may comprise one or more transaction amounts associated with preauthorized recurring transactions.

Corresponding apparatuses, devices, systems, and computer-readable media (e.g., non-transitory computer readable media) are also within the scope of the disclosure.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1 illustrates an example of a computing system that may be used to implement one or more aspects of the disclosure in accordance with one or more illustrative aspects discussed herein;

FIG. 2 is an illustrative flowchart representation of the process of detecting and preventing the blockage of preauthorized recurring transactions according to aspects of the disclosure;

FIG. 3 is an illustrative flowchart of a machine learning model determining a probability that an incoming charge is a preauthorized recurring transaction according to aspects of the disclosure;

FIG. 4 is an illustrative flowchart of one aspect of FIG. 2, in which the machine learning model is trained using various training data according to aspects of the disclosure;

FIG. 5 is an illustrative flowchart representation of a machine learning model determine the probability that an incoming charge is a preauthorized recurring transaction according to aspects of the disclosure;

FIG. 6 is an example of a computing device receiving a notification regarding an incoming charge according to aspects of the disclosure;

FIG. 7 illustrates an example of processing transaction data for an incoming charge according to aspects of the disclosure;

FIG. 8 depicts the data flow of transaction data associated with incoming charges of a merchant according to aspects of the disclosure; and

FIG. 9 is an illustrative flowchart representation of the process for training a transaction identification model according to aspects of the disclosure.

### DETAILED DESCRIPTION

In the following description of the various embodiments, reference is made to the accompanying drawings, which form a part hereof, and in which is shown by way of illustration various embodiments in which aspects of the disclosure may be practiced. It is to be understood that other embodiments may be utilized and structural and functional modifications may be made without departing from the scope of the present disclosure. Aspects of the disclosure are capable of other embodiments and of being practiced or being carried out in various ways. Also, it is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof.

There has been an increase in the popularity of subscription services to which a consumer may subscribe and receive some goods and/or services on a fixed (e.g., a one year subscription that ends after one year) or open-ended basis (e.g., a month to month subscription that continues indefinitely or until canceled). These good or services may include subscriptions to online streaming media services, fitness club memberships, food delivery services, online gaming services, or any other goods or services to which a consumer may create a subscription and pay incoming charges for the service on a preauthorized recurring basis. For example, a consumer may subscribe to a gaming service that charges an agreed upon amount on a monthly basis. While preauthorization of recurring payments for services is convenient and relieves the consumer of the burden of having to repeatedly perform the steps of manually paying for a service it may also create issues for the consumer. For example, it may be difficult for a consumer to keep track of the services to which the consumer is currently subscribed, which services have been cancelled, and which services are recurring. Further, a consumer may lose track of services that are used infrequently or sporadically. In the case of cancelled services, to avoid additional charges for cancelled services, a consumer may wish to block incoming charges from the associated merchant.

However, blocking a merchant may mean that all incoming charges from that merchant, not just the incoming charges for services the consumer no longer wishes to subscribe to, may be blocked. In some cases a consumer may wish to use other services provided by the same blocked merchant and must then either unblock the merchant or manually prevent specific incoming charges of a blocked merchant from being blocked. To overcome these issues, different approaches may be taken, for example, identifying incoming charges that are recurring transactions.

However, all recurring transactions are not preauthorized recurring transactions. For example, a consumer may make recurring purchases (e.g., payment for three meals purchased from the same restaurant on three consecutive Saturday evenings) that are not preauthorized. Further, all preauthorized transactions are not recurring. For example, a consumer may preauthorize a one-time payment that is not recurring (e.g., preauthorization of payment of an installation fee for the pre-scheduled installation of an air conditioning unit). The disclosed technology addresses and resolves these issues by leveraging the use of a machine learning model that is configured to determine the probability that an incoming charge associated with a blocked merchant is a preauthorized recurring transaction. The determined probability that the incoming charge is a preauthorized recurring transaction may then be used to determine whether the incoming charge should remain blocked or processed (e.g., debiting an account of the consumer that made the purchase associated with the incoming charge).

When an incoming charge associated with a merchant is received by a financial institution, computing devices of the financial institution may determine whether the merchant is on a blocked merchants list that indicates merchants whose incoming charges shall be blocked. If the merchant associated with the incoming charge is on the blocked merchants list, the computing device may use a transaction identification model, trained using machine learning techniques, to analyze the incoming charge and determine a probability of the incoming charge being a preauthorized recurring transaction. The computing device may then prevent authorization of incoming charges that are determined to have a low probability of being a preauthorized recurring charge.

Aspects discussed herein may relate to methods and techniques for determining whether a merchant associated with an incoming charge is on a blocked merchants list and then determining the probability of that incoming charge being a preauthorized recurring transaction that may need to be unblocked and/or processed. The aspects described herein allow incoming charges not to be inappropriately blocked without lifting the block that is associated with a blocked merchant.

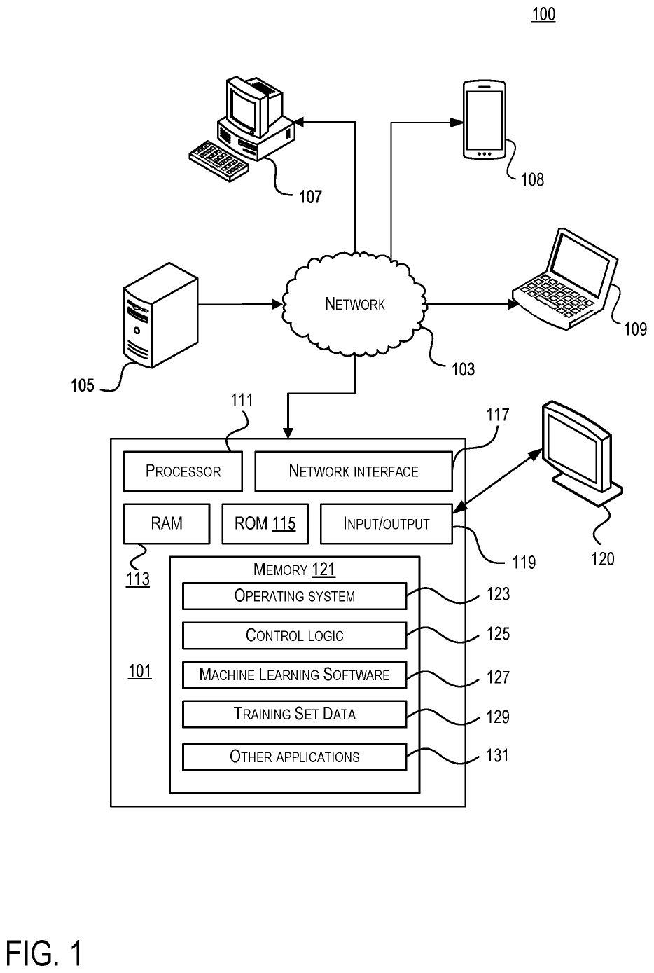

Before discussing these concepts in greater detail, however, several examples of a computing device that may be used in implementing and/or otherwise providing various aspects of the disclosure will first be discussed with respect to FIG. 1.

FIG. 1 illustrates one example of a computing device 101 that may be used to implement one or more illustrative aspects discussed herein. For example, computing device 101 may, in some embodiments, implement one or more aspects of the disclosure by reading and/or executing instructions and performing one or more actions based on the instructions. In some embodiments, computing device 101 may represent, be incorporated in, and/or include various devices such as a desktop computer, a computer server, a mobile device (e.g., a laptop computer, a tablet computer, a smartphone, any other types of mobile computing devices, and the like), and/or any other type of data processing device.

Computing device 101 may, in some embodiments, operate in a standalone environment. In other embodiments, computing device 101 may operate in a networked environment. As shown in FIG. 1, various network nodes 101, 105, 107, 108, and 109 may be interconnected via a network 103, such as the Internet. Other networks may also or alternatively be used, including private intranets, corporate networks, LANs, wireless networks, personal networks (PAN), and the like. Network 103 is for illustration purposes and may be replaced with fewer or additional computer networks. A local area network (LAN) may have one or more of any known LAN topology and may use one or more of a variety of different protocols, such as Ethernet. Devices 101, 105, 107, 108, 109 and other devices (not shown) may be connected to one or more of the networks via twisted pair wires, coaxial cable, fiber optics, radio waves or other communication media.

As seen in FIG. 1, computing device 101 may include a processor 111, RAM 113, ROM 115, network interface 117, input/output interfaces (I/O) 119 (e.g., keyboard, mouse, display, printer, etc.), and memory 121. Processor 111 may include one or more computer processing units (CPUs), graphical processing units (GPUs), and/or other processing units such as a processor adapted to perform computations associated with machine learning. I/O 119 may include a variety of interface units and drives for reading, writing, displaying, and/or printing data or files. I/O 119 may be coupled with a display such as display 120. Memory 121 may store software for configuring computing device 101 into a special purpose computing device in order to perform one or more of the various functions discussed herein. Memory 121 may store operating system software 123 for controlling overall operation of computing device 101, control logic 125 for instructing computing device 101 to perform aspects discussed herein, machine learning model 127 (e.g., software comprising instructions to implement a machine learning model), training dataset 129, and other applications 131. Control logic 125 may be incorporated in and may be a part of machine learning model 127. In other embodiments, computing device 101 may include two or more of any and/or all of these components (e.g., two or more processors, two or more memories, etc.) and/or other components and/or subsystems not illustrated here.

Devices 105, 107, 108, 109 may have similar or different architecture as described with respect to computing device 101. Those of skill in the art will appreciate that the functionality of computing device 101 (or device 105, 107, 108, 109) as described herein may be spread across multiple data processing devices, for example, to distribute processing load across multiple computers, to segregate transactions based on geographic location, user access level, quality of service (QOS), etc. For example, devices 101, 105, 107, 108, 109, and others may operate in concert to provide parallel computing features in support of the operation of control logic 125 and/or machine learning model 127.

One or more aspects discussed herein may be embodied in computer-usable or readable data and/or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) HTML or XML. The computer executable instructions may be stored on a computer readable medium such as a hard disk, optical disk, removable storage media, solid state memory, RAM, etc. As will be appreciated by one of skill in the art, the functionality of the program modules may be combined or distributed as desired in various embodiments. In addition, the functionality may be embodied in whole or in part in firmware or hardware equivalents such as integrated circuits, field programmable gate arrays (FPGA), and the like. Particular data structures may be used to more effectively implement one or more aspects discussed herein, and such data structures are contemplated within the scope of computer executable instructions and computer-usable data described herein. Various aspects discussed herein may be embodied as a method, a computing device, a data processing system, or a computer program product.

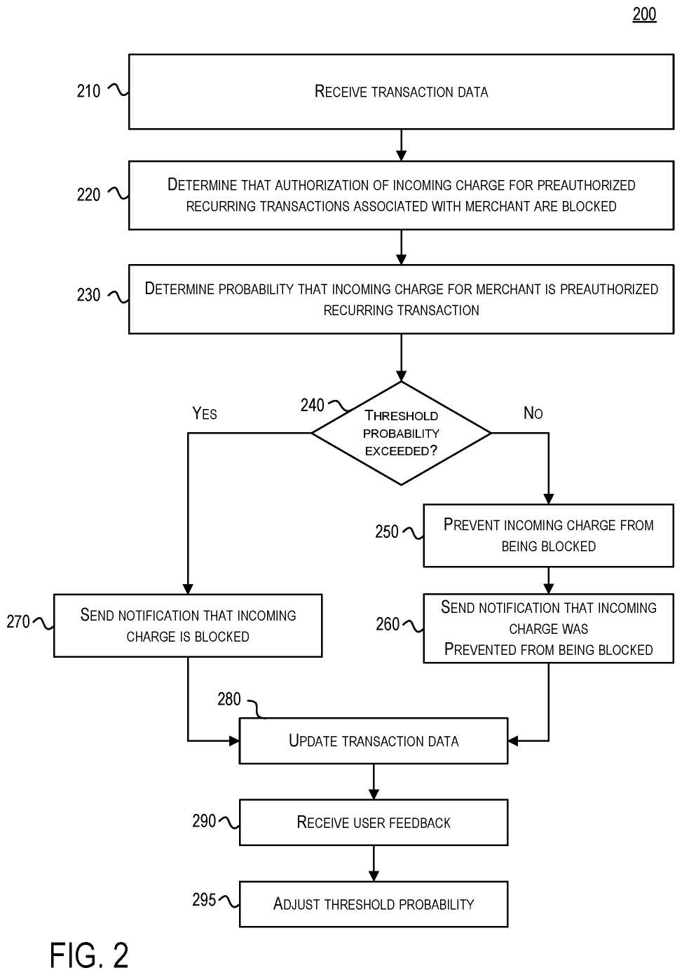

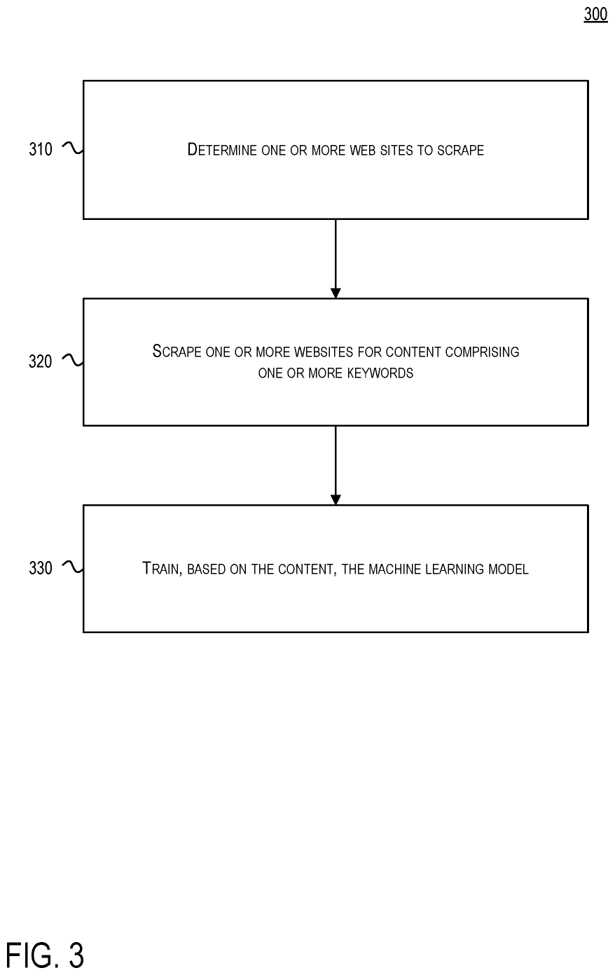

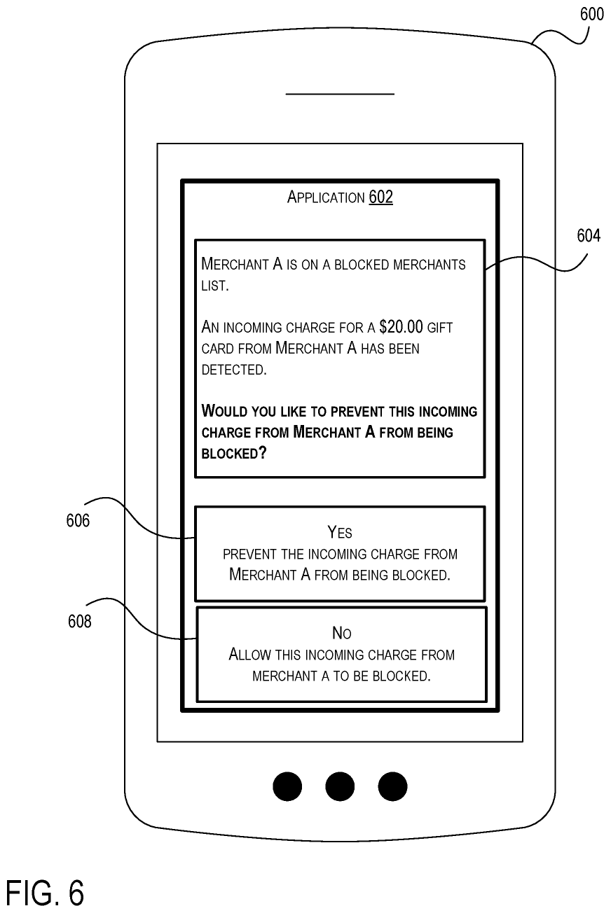

FIG. 2 depicts an example of a method flow for detecting and preventing the blockage of preauthorized recurring transactions. FIG. 2 provides a high-level representation of one embodiment for this process. These steps are broken down further in FIGS. 3 and 6.

In step 210, a computing device (e.g., a computing device associated with a financial institution) may receive transaction data comprising transaction details for an incoming charge associated with a merchant. The transaction data may be received in real time, near real time (e.g., at or close to the time of the transaction associated with the incoming charge), or at a time that is not closely proximate to the time of the transaction associated with the incoming charge (e.g., the day after the transaction). Further, the transaction data may be structured in accordance with a data standard used to process payments electronically and/or to exchange electronic transactions using payment cards (e.g., the transaction data may be structured in accordance with the ISO 8583 standard or another standard that is used for financial transaction card messages). The incoming charge may for example comprise an incoming charge for some good and/or service. For example, the incoming charge may comprise an incoming charge for a subscription to an online video streaming service or the purchase of an article of clothing.

The transaction data may comprise the name of the merchant associated with the incoming charge. For example, the transaction data may comprise a merchant identifier field that indicates the name of the merchant and/or a merchant identifier (e.g., a numeric code) that may be used to identify the merchant. Further, the transaction data may comprise a payment mechanism field that may indicate a payment mechanism that is used as part of the transaction. For example, the payment mechanism may comprise a card such as a credit card, a debit card, virtual card numbers (VCNs), mobile wallets, cryptocurrency, and/or prepaid account. Further, the payment mechanism may be associated with a financial institution. For example, the financial institution may comprise a bank, a third-party payment processors, and/or cryptocurrency wallet applications.

The transaction data may be stored and/or distributed on a distributed network, similar to network 103, and on computing devices similar to computing devices 101 and/or 105. Further, the transaction data may be accessed by a computing device, which may include the computing devices 101, 105, 107, 108, 109, any of which may access the transaction data over a network (e.g., a network similar to network 103).

In step 220, the computing device may determine that authorization of incoming charges for preauthorized recurring transactions associated with the merchant are blocked. A preauthorized recurring transaction may comprise a transaction (e.g., a transaction between a consumer and a merchant in which a good or service of the merchant is purchased by the consumer) that is preauthorized (e.g., a consumer has authorized payment for future incoming charges for a good or service) and recurring (e.g., the incoming charge occurs more than once and may occur on a periodic basis). For example, an incoming charge for a preauthorized recurring transaction may comprise an incoming charge for a video streaming service or fitness center membership that is charged on a monthly basis. An example of an incoming charge associated with a transaction that is not a preauthorized recurring transaction may comprise an incoming charge for a one-time purchase of a movie ticket on a particular day or the one-time purchase of a beverage at a restaurant. By way of further example, the preauthorized recurring transactions may comprise one or more online service subscriptions (e.g., a subscription to an online chat service), one or more product delivery subscriptions (e.g., a subscription to a food delivery service), and/or one or more news media subscriptions (e.g., a subscription to a video or print news service).

Determination that authorization of the incoming charges for preauthorized recurring transactions associated with the merchant are blocked may be based on the determination that the merchant is included in a blocked merchants list. For example, the computing device may access a blocked merchants list and compare the name and/or merchant identifier of the merchant indicated in the transaction data to the names of merchants in the blocked merchants list. If the name and/or merchant identifier associated with the merchant indicated in the transaction data matches that of a merchant in the blocked merchants list then there may be a determination that authorization of incoming charges, including incoming charges for preauthorized recurring transactions, associated with the merchant may be blocked. If the name and/or merchant identifier associated with the merchant indicated in the transaction data does not match that of a merchant in the blocked merchants list then there may be a determination that authorization of incoming charges, including incoming charges for preauthorized recurring transactions, associated with the merchant shall not be blocked (e.g., the incoming charge may be authorized).

The blocked merchants list may be stored on a database (e.g., the computing device 101 or 105). Further, the blocked merchants list may be stored in memory (e.g., the memory 121) or in RAM (e.g., the RAM 113) of the database. In some embodiments, the blocked merchants list may be stored locally on the computing device 108 (e.g., in memory 121 or RAM 113).

The blocked merchants list may comprise a set of merchant identifiers that may be used to identify a merchant associated with a transaction. Further, the blocked merchants list may be used to block some portion of incoming charges (e.g., all incoming charges associated with the merchant or a subset of incoming charges associated with the merchant). For example, the blocked merchants list may be used to block incoming charges associated with a merchant irrespective of the type and/or amount of the incoming charge. By way of further example, the blocked merchants list may be used to block a subset of incoming charges comprising incoming charges processed via a particular payment mechanism (e.g., a debit card transaction), an incoming charge that exceeds a certain amount, and/or an incoming charge that is processed by a particular credit card or debit card (e.g., a consumer may have multiple credit cards some of which may be associated with incoming charges from a particular merchant).

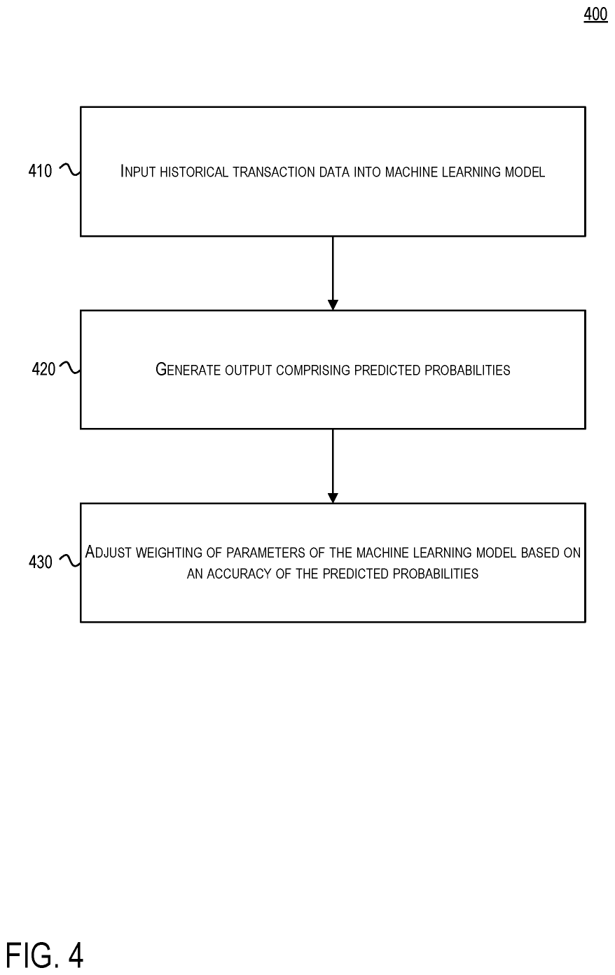

In step 230, the computing device may determine, based on a machine learning model and the transaction data, a probability that the incoming charge for the merchant is a preauthorized recurring transaction. The machine learning model may be configured to identify preauthorized recurring transactions based on the transaction data. For example, the machine learning model may receive an input comprising the transaction data. The machine learning model may then perform operations on the input. The operations may comprise determining features of the transaction data that may be used to determine a probability that the incoming transaction indicated in the transaction data is a preauthorized recurring transaction. The machine learning model may then generate an output comprising a probability that the incoming charge for the merchant is a preauthorized recurring transaction. An example of training of the machine learning model is described with respect to FIG. 4.

In step 240, based on the probability (e.g., the probability that the incoming charge for the merchant is a preauthorized recurring transaction) not exceeding a threshold probability, the step 250 may be performed. For example, the probability determined by the machine learning model may be compared to the threshold probability and if the probability is less than or equal to the threshold probability then step 250 may be performed.

Based on the probability exceeding a threshold probability, step 270 may be performed. For example, the probability determined by the machine learning model may be compared to a threshold probability and if the probability is greater than the threshold probability then step 270 may be performed.

In step 250, the computing device may, based on the probability (e.g., the probability that the incoming charge for the merchant is a preauthorized recurring transaction) not exceeding a threshold probability, prevent the authorization of the incoming charge from being blocked. The probability of the incoming charge for the merchant being a preauthorized recurring transaction exceeding the probability threshold may indicate that the incoming charge is more likely not to be a preauthorized recurring transaction. For example, if the machine learning model determines that there is a ninety seven percent probability that the incoming charge for the merchant is a preauthorized recurring transaction and the threshold probability is ninety five percent, then the financial institution may prevent authorization of the incoming charge from being blocked (e.g., the incoming charge may be processed despite the merchant associated with the incoming charge being on the blocked merchants list).

In step 260, based on the probability (e.g., the probability that the incoming charge for the merchant is a preauthorized recurring transaction) not exceeding the threshold probability, the computing device may send a notification to a user. The notification may indicate that authorization of the incoming charge is not being blocked. The notification may be sent from an internal server, such as computing device 105, and may be sent over network 103 to the user that the incoming charge will be processed. This notification may be included in a message comprising an e-mail, text message, and/or an automated phone call. The notification may be received by a user on a computing device similar to computing devices 101, 107, 108, or 109. In one embodiment, the user may receive the notification on a mobile device operated by the user, similar to computing device 108, and via an application provided by the financial institution for the purpose of granting mobile access for users to manage financial accounts.

In step 270, based on the probability (e.g., the probability that the incoming charge for the merchant is a preauthorized recurring transaction) exceeding the threshold probability, the computing device may send a notification to a user. The probability of the incoming charge for the merchant being a preauthorized recurring transaction not exceeding the probability threshold may indicate that the incoming charge is more likely to be a preauthorized recurring transaction. The notification may indicate that the merchant associated with the incoming charge is on a blocked merchants list and that authorization of the incoming charge will be blocked. For example, if the probability exceeds the threshold probability (e.g., the incoming charge is likely to be a preauthorized recurring transaction), then a notification (e.g., a text message or e-mail) may be sent to a user's computing device and the message may indicate that the incoming charge is being blocked.

In some embodiments, the notification to the user may prompt the user to either confirm that the incoming charge should be blocked or request that the incoming charge be unblocked. For example, the notification may comprise a message with two options comprising a first option to “CONFIRM BLOCKAGE OF THE INCOMING CHARGE” and a second option to “ALLOW THE INCOMING CHARGE TO BE PROCESSED.” If the user selects the first option to confirm blockage of the incoming charge, the incoming charge will remain blocked. If the user selects the second option to allow the incoming charge to be processed, a signal indicating that the user wishes for the incoming charge to be authorized may be sent from the user's computing device to a computing device associated with the financial institution.

In step 280, the computing device may update the transaction data. Based on the probability (e.g., the probability that the incoming charge for the merchant is a preauthorized recurring transaction) not exceeding the threshold probability, the computing device may update the transaction data to indicate that the incoming charge is not a preauthorized recurring transaction. For example, the computing device may access a recurring transaction field or transaction description field of the transaction data and enter a value indicating that the transaction is not a preauthorized recurring transaction (e.g., the description may indicate that the incoming charge is associated with a one-time food purchase).

Based on the probability (e.g., the probability that the incoming charge for the merchant is a preauthorized recurring transaction) exceeding the threshold probability, the computing device may update the transaction data to indicate that the incoming charge is a preauthorized recurring transaction. For example, the computing device may access a recurring transaction field or transaction description field of the transaction data and enter a value indicating that the transaction is a preauthorized recurring transaction (e.g., the description may indicate that the incoming charge is associated with a subscription to a gaming service).

In step 290, the computing device may receive user feedback. The user feedback may be with respect to an accuracy with which the machine learning model identifies preauthorized recurring transactions. Further, as part of the process of receiving user feedback a request for user feedback may be sent to a user's computing device and the request for user feedback may comprise questions regarding the accuracy with which the machine learning model identified preauthorized recurring transactions. For example, the request for user feedback may ask that the user indicates whether an incoming charge was blocked or processed appropriately (e.g., an incoming charge that should have been blocked was blocked or an incoming charge that should have been processed was processed) or inappropriately (e.g., an incoming charge that should have been processed was blocked or an incoming charge that should have been blocked was processed). The user may then provide feedback indicating whether or not an incoming charge was appropriately blocked or processed.

In step 295, the computing device may adjust the threshold probability based on the user feedback. For example, if the user feedback indicates that an incoming charge was inaccurately determined to be a preauthorized recurring transaction, the computing device may increase the threshold probability. As such, the machine learning model will have to determine a greater probability that an incoming charge is a preauthorized recurring transaction before an incoming charge is blocked.

FIG. 3 is an illustrative flowchart of a machine learning model determining a probability that an incoming charge is a preauthorized recurring transaction according to aspects of the disclosure.

In step 310, the computing device may determine one or more websites to scrape based on use of a browser extension that is configured to detect one or more keywords associated with preauthorized recurring transactions. For example, after the browser extension detects that a web page of a website associated with a merchant has been accessed, the browser extension may scrape one or more web pages to determine whether web pages of the websites comprise one or more key words associated with a preauthorized recurring transaction for the merchant. For example, the browser extension may detect that a user is at a web page associated with a transaction (e.g., a subscription page, a payment page, and/or a service renewal page associated with the merchant). The determination that a user is at a web page associated with a transaction may be based on detection of one or more payment fields within a web page. Based on detecting the one or more payment fields, the browser extension may then search the web page for one or more key words associated with preauthorized recurring transactions. For example, the browser extension may search for one or more key words comprising subscription, subscribe, preauthorized, recurring, transaction, renewal, payment, monthly, weekly, annual, and/or yearly.

By way of further example, after detecting that a user is at a web page associated with a transaction, the browser extension may search the web page for content comprising one or more transaction amounts (e.g., one or more monetary amounts associated with the purchase of goods or services) associated with preauthorized recurring transactions. For example, if the computing device has determined that the merchant offers subscription services for $14.99 per month, the browser extension may search for a transaction amount of $14.99. When the transaction amount of $14.99 is found, the browser extension may determine whether the transaction amount is in close proximity to (e.g., adjacent to) some indication (e.g., the one or more keywords) that the transaction amount is a preauthorized recurring transaction. If the transaction amount and/or the one or more key words are associated with preauthorized recurring transactions, the browser extension may determine that one or more websites associated with the web page shall be scraped.

As described herein, a browser extension may be an extension of a browser application that is implemented on a computing device (e.g., the computing devices 101, 107, 108, and/or 109) in order to access websites via a network (e.g., the network 103 illustrated in FIG. 1). In some aspects, the browser extension may be part of a standalone application that may be used to browse websites associated with a particular merchant or a set of merchants.

In step 320, a computing device may scrape one or more websites associated with a merchant for content comprising one or more key words associated with preauthorized recurring transactions. As part of scraping the one or more websites the computing device may access a website associated with a merchant (e.g., a website at which goods or services or a merchant may be purchased), the computing device may search web pages of the website for one or more key words associated with preauthorized recurring transactions. For example, the browser extension may search for one or more key words comprising subscription, subscribe, preauthorized, recurring, transaction, renewal, payment, monthly, weekly, annual, and/or yearly. Scraping the one or more websites for the content may comprise generating statistics that indicate the frequency of the one or more keywords, the frequency of different combinations of the one or more keywords, the location of the one or more keywords within the web pages, and/or the location of the one or more keywords relative to one or more other keywords.

In step 330, the computing device may train the machine learning model. The machine learning may be trained based on the content comprising the one or more key words. Training the machine learning model may comprise providing an input comprising the one or more key words to the machine learning model. The machine learning model may comprise parameters (e.g., adjustable weights and fixed biases) and each of the weights of the machine learning model may be adjusted based on the extent to which each of the weights contributes to increasing or decreasing the accuracy of output generated by the machine learning model. Based on use of a loss function, the parameters may be adjusted such that the loss is minimized (e.g., the output of the machine learning model more closely corresponds to ground truth output that represents optimal output). For example, the parameters that contribute to increasing the accuracy of the output of the machine learning model may be increased and the parameters that contribute to decreasing the accuracy of the machine learning model may be decreased.

For example, the machine learning model may receive input comprising key words (combinations of key words may form key phrases) from a web site of a merchant. The ground truth data may comprise sets of key words that are present in the transaction data (e.g., the transaction description field) of incoming charges that are preauthorized recurring transactions. The machine learning model may be trained to determine the probability that an incoming charge is a preauthorized recurring transaction based on the extent to which the probability that an incoming charge is a preauthorized recurring transaction corresponds to whether the incoming charge is actually a preauthorized recurring transaction.

FIG. 4 is an illustrative flowchart of one aspect of FIG. 2, in which the machine learning model is trained using various training data according to aspects of the disclosure.

In step 410, the computing device may input historical transaction data into the machine learning model. The historical transaction data may comprise historical incoming charges of a plurality of merchants. For example, the historical transaction data may comprise at least one of an amount of time between historical preauthorized recurring transactions (e.g., the duration between incoming charges for preauthorized recurring transactions), one or more dates (e.g., days of the month) on which the historical preauthorized recurring transactions were posted, and/or one or more monetary amounts of the historical preauthorized recurring transaction. Further, the historical incoming charges may be associated with ground truth labels indicating whether each of the historical incoming charges is either a preauthorized recurring transaction or not a preauthorized recurring transaction. As a result, when a predicted probability of an incoming charge being a preauthorized recurring transaction is generated, the ground truth labels may be used to determine the accuracy of the machine learning model with respect to the predicted probabilities that were generated.

In step 420, the computing device may generate, based on the machine learning model and the historical transaction data, output comprising predicted probabilities that the historical incoming charges are preauthorized recurring transactions. For example, the machine learning model may analyze one or more features of the historical transaction data based in part on the configuration of parameters of the machine learning model. The machine learning model may then generate predicted probabilities comprising probabilities that each of the historical incoming charges is a preauthorized recurring transaction.

In step 430, the computing device may adjust a weighting of parameters of the machine learning model based on an accuracy of the predicted probabilities. For example, the weighting of parameters that are determined to make a greater contribution to accurately predicting whether a historical incoming charge is preauthorized recurring transaction may be increased. Further, the weighting of parameters that are determined to make a lesser contribution (or no contribution) to accurately predicting whether a historical incoming charge is a preauthorized recurring transaction may be decreased. The machine learning model may be iteratively trained until the accuracy of the predicted probabilities is sufficiently high.

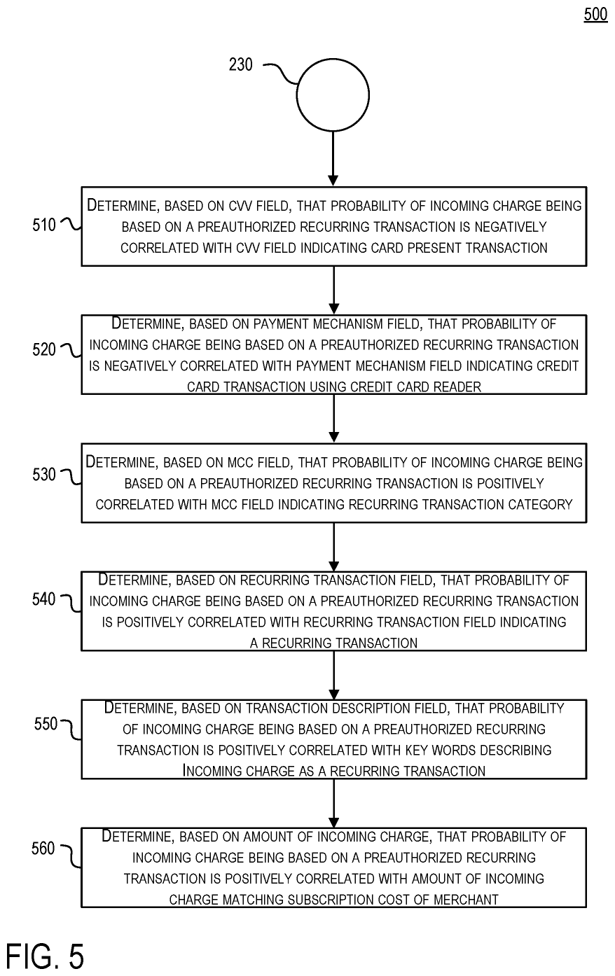

FIG. 5 is an illustrative flowchart of a machine learning model determining a probability that an incoming charge is a preauthorized recurring transaction according to aspects of the disclosure.

In step 510, the machine learning model (e.g., a machine learning model similar to the machine learning model 127 in FIG. 1) may determine, based on the value of a CVV field of the transaction data, that the probability of the incoming charge being based on a preauthorized recurring transaction is negatively correlated with the CVV field indicating that the incoming charge is based on a card present transaction (e.g., an incoming charge for a card present is less likely to be a preauthorized recurring transaction). For example, the machine learning model may receive transaction data indicating that the CVV value of a CVV field for an incoming charge indicates a card present transaction in which a physical credit card was used to perform the transaction associated with the incoming charge. Based on the value indicated in the CVV value and the greater likelihood that card present transactions are more likely to be for one-time purchases, the machine learning model may reduce the probability of the incoming charge being a preauthorized recurring transaction that is generated.

In step 520, the machine learning model may determine, based on a payment mechanism field of the transaction data, that the probability of the incoming charge being based on a preauthorized recurring transaction is negatively correlated with the payment mechanism field indicating that the incoming charge is based on a credit card transaction using a card reader device or a mobile wallet transaction using a mobile device and a contactless point of sale system. For example, the machine learning model may receive transaction data indicating that the payment mechanism for an incoming charge indicates the use of a prepaid account associated with a restaurant chain (e.g., a prepaid gift card) to perform the transaction associated with the incoming charge. Based on the payment mechanism being a prepaid account associated with a restaurant chain and thereby more likely to be a one-time purchase, the machine learning model may reduce the probability of the incoming charge being a preauthorized recurring transaction.

In step 530, the machine learning model may determine, based on a merchant category code field of the transaction data, that the probability of the incoming charge being based on a preauthorized recurring transaction is positively correlated with the merchant category code (e.g., a four digit code indicating the type of good or service provided by a merchant) field indicating that a category of goods or services provided by the merchant correspond to a preauthorized recurring transaction. For example, the machine learning model may receive transaction data indicating that the merchant category code associated with an incoming charge indicates that the merchant is part of a chain of fitness centers which increases the likelihood that the incoming charge is for the type of good or service that is more likely to be a preauthorized recurring transaction. Based on the merchant category code indicating that the merchant is part of a chain of fitness centers, the machine learning model may increase the probability of the incoming charge being a preauthorized recurring transaction.

In step 540, the machine learning model may determine, based on a recurring transaction field of the transaction data, that the probability of the incoming charge being based on a preauthorized recurring transaction is positively correlated with the recurring transaction field indicating that the incoming charge is a recurring transaction. For example, the machine learning model may receive transaction data indicating that the recurring transaction value of a recurring transaction field for an incoming charge indicates that the incoming charge is a recurring transaction. Based on the recurring transaction field indicating a recurring transaction, the machine learning model may increase the probability of the incoming charge being a preauthorized recurring transaction.

The recurring transaction field may not be dispositive of a preauthorized recurring transaction. Further, the value in the recurring transaction field may have been erroneously entered and other portions of the transaction data may contraindicate the value in the recurring transaction field. For example, if the recurring transaction field indicates that an incoming charge is a recurring transaction, other portions of the transaction data such as a transaction description field indicating that the incoming charge is for the purchase of a theater ticket on a particular day may reduce the probability that the incoming charge is a preauthorized recurring transaction.

In step 550, the machine learning model may determine, based on a transaction description field of the transaction data, that the probability of the incoming charge being based on a preauthorized recurring transaction is positively correlated with one or more key words describing the incoming charge as a preauthorized recurring transaction. For example, the machine learning model may receive transaction data in which the transaction description field indicates that the incoming charge is for a “MONTHLY MAGAZINE SUBSCRIPTION PAYMENT” which includes the key words “monthly” and “subscription” which are associated with a preauthorized recurring payment. Based on the one or more key words comprising “monthly” and “subscription” the machine learning model may increase the probability of the incoming charge being a preauthorized recurring transaction.

In step 560, the machine learning model may determine that the probability of the incoming charge being based on a preauthorized recurring transaction is positively correlated with an amount of the transaction matching a subscription cost of the merchant. For example, the machine learning model may receive transaction data indicating that the amount (e.g., the monetary amount) of the incoming charge is “$12.99” which exactly matches the price of a subscription to a gaming service of the merchant. Based on the amount of the incoming charge matching the subscription cost of the merchant, the machine learning model may increase the probability of the incoming charge being a preauthorized recurring transaction.

FIG. 6 is an example of a computing device receiving a notification regarding an incoming charge according to aspects of the disclosure. In this example, a notification is sent to the user device 600. For example, a computing system of a financial institution may send (to user device 600 similar to computing device 108 from FIG. 1) a notification alerting the user of an incoming charge that may be a preauthorized recurring transaction. The notification may be generated from within an application 602 that the user accesses from user device 600. In some embodiments, the user device 600 may be similar to computing device 101, 107, or 109.

The notification may include a message 604, which indicates “MERCHANT A IS ON A BLOCKED MERCHANTS LIST.” The message 604 may also indicate that “AN INCOMING CHARGE FOR A $20.00 GIFT CARD FROM MERCHANT A HAS BEEN DETECTED” which indicates the good that is associated with the incoming charge. The message further indicates “WOULD YOU LIKE TO PREVENT THIS INCOMING CHARGE FROM MERCHANT A FROM BEING BLOCKED?” which provides a user with the option of preventing the incoming charge from a blocked merchant from being blocked. The user may then respond to the message 604 by selecting either the interactive element 606 or the interactive element 608.

In this embodiment, if a user selects the interactive element 606, the incoming charge may be prevented from being blocked. For example, the interactive element 606 may be configured to initiate the sending of an API request to allow the incoming charge to be processed despite the associated merchant being blocked. If the user selects the interactive element 608, actions to prevent the incoming charge from being blocked will not be performed and the incoming charge will be blocked.

In some embodiments, user device 600 may display a confirmation message to confirm that blocking of the incoming charge has either been prevented or allowed. For example, if a user selected “YES” to prevent the incoming charge from being blocked, the user device may generate a text message indicating that the incoming charge was not blocked and then send the text message to the user device 600.

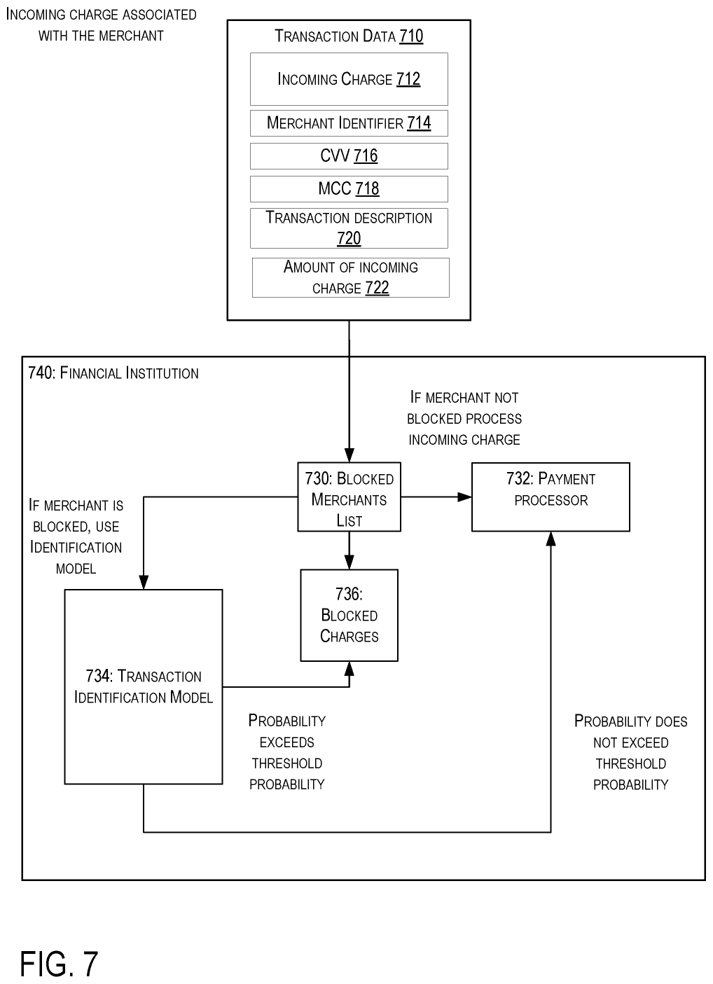

FIG. 7 illustrates an example of processing transaction data for an incoming charge according to aspects of the disclosure.

Transaction data 710 may be associated with an incoming charge made by a merchant for a preauthorized recurring transaction. The transaction data 710 may include an incoming charge 712, a merchant identifier 714, a CVV 716, a merchant category code 718, a transaction description 720, and an amount of the incoming charge 722. In one embodiment, the transaction data 710 may be structured in accordance with the ISO 8385 API. In other embodiments, the transaction data may be structured in accordance with any API accepted and processed by one or more computing devices of the financial institution 740 by the payment processor 732.

The incoming charge 712 may indicate a good or service for which a consumer may receive an incoming charge. The merchant identifier 714 may comprise data that may be used to identify the merchant, and may comprise the merchant's name, a merchant ID number, and/or descriptive text that may comprise merchant-identifying information The CVV 716 may indicate a card verification value that is used to improve security for credit card transactions, the presence of which may indicate that the incoming charge is associated with a credit card transaction. The merchant category code (MCC) 718 may indicate the type of goods and/or services the merchant provides. The transaction description 720 may comprise a free form text description of the goods and/or services associated with the incoming transaction. The amount of the incoming charge 722 may indicate a monetary value (e.g., a dollar amount or euro amount) associated with the incoming charge.

After being received by a computing device of the financial institution 740, the transaction data 710 may be compared to the blocked merchants list 730 as described in step 220 that is depicted in FIG. 2. If the merchant indicated in the merchant identifier 714 is not on the blocked merchants list 730, the transaction data 710 may be processed using the payment processor 732. If the merchant indicated in the merchant identifier 714 is on the blocked merchants list 730, the transaction data 710 may be sent to the transaction identification model 734 which may process the transaction data 710 and perform operations to determine whether the incoming charge 712 for the merchant is a preauthorized recurring transaction. The transaction identification model 734, which may be similar to machine learning model 127 from FIG. 1 or the machine learning model described in step 230, may use the transaction data as an input that is used to generate output comprising a probability that the incoming charge 712 is a preauthorized recurring transaction. If the probability that the incoming charge 712 is a preauthorized recurring transaction exceeds a threshold probability, the incoming charge 712 is blocked and included in the blocked charges 736 which comprises incoming charges that were blocked within a predetermined time period (e.g., the past month or the past year). If the probability that the incoming charge 712 is a preauthorized recurring transaction does not exceed the threshold probability, the incoming charge 712 may be processed by the payment processor 732.

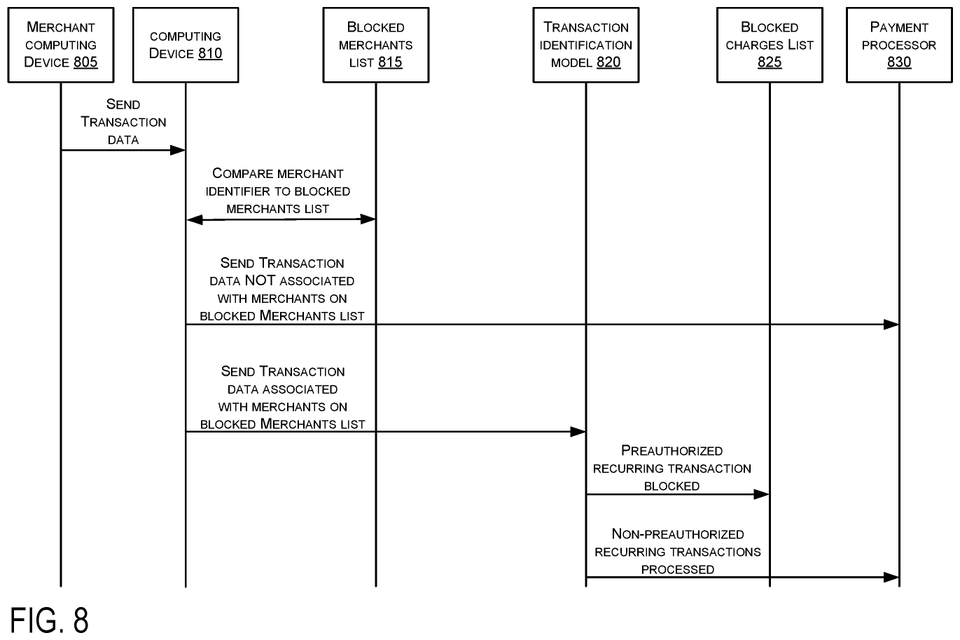

FIG. 8 depicts the data flow of transaction data associated with incoming charges of a merchant according to aspects of the disclosure.

The merchant computing device 805 (e.g., a computing device that stores and/or processes transaction data for a merchant) may send transaction data comprising an indication associated with an incoming charge for the merchant's goods or services to the computing device 810. The computing device 810 may be similar to other computing devices described herein (e.g., the computing device described in the steps illustrated in FIG. 2) as being configured to determine the probability of an incoming charge being a preauthorized recurring transaction.

The computing device 810 may compare a merchant identifier (e.g., a merchant identifier associated with a merchant) indicated in the transaction data to data in a blocked merchants list 815 that includes a list of merchants whose incoming charges have been blocked (e.g., merchants that a consumer has added to the blocked merchants list). The blocked merchants list 815 may be stored locally or on another computing device that the computing device 810 may access. If the merchant identifier indicated in the transaction data is not included in the blocked merchants list 815, the transaction data may be sent to the payment processor 830, which may process the incoming charge associated with the transaction data. If the merchant identifier indicated in the transaction data is included in the blocked merchants list 815, the transaction data may be sent to a transaction identification model 820, which may be implemented on the computing device 810 and/or on some other remote computing device that the computing device 810 is able to access.

The transaction identification model 820 (e.g., a machine learning model similar to the machine learning model 127) may be configured to use the transaction data as an input to determine the probability of the incoming charge of the merchant being a preauthorized recurring transaction. The transaction identification model 820 may be implemented on the computing device 810 and/or on some other remote computing device that the computing device 810 is able to access.

If the transaction identification model 820 determines that the probability of the incoming charge from the merchant exceeds a probability threshold then the incoming charge may be added to the blocked charges list 825, which may include blocked charges from the merchant and/or other merchants. The blocked charges list 825 may be stored on the computing device 810 and/or on a computing device that is accessible to the computing device 810 and/or other computing devices that may be accessed by the computing device 810.

If the transaction identification model 820 determines that the probability of the incoming charge from the merchant does not exceed a probability threshold then the incoming charge may be processed by the payment processor computing device 830. The payment processor computing device 830 may be operated by a payment processor that is authorized to request and/or withdraw funds from an account of a user associated with the incoming charge.

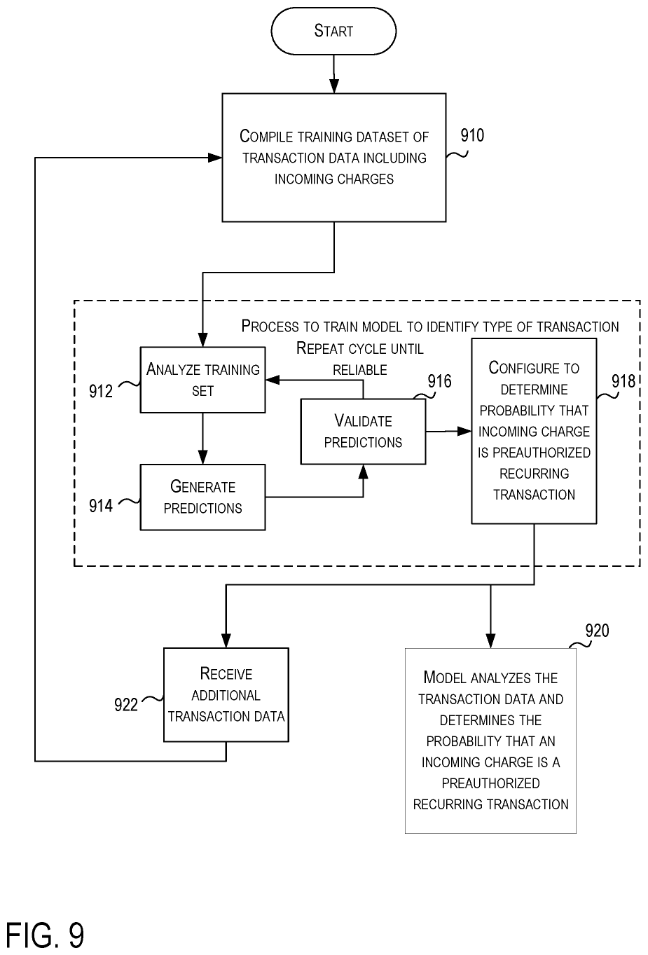

FIG. 9 is an illustrative flowchart representation of a process for training a transaction identification model according to aspects of the disclosure.

The training dataset may be compiled in step 910. The training dataset, may be similar to the training dataset 129 depicted in FIG. 1, and may be based on transaction data from a plurality of merchants and/or users (e.g., consumers of goods and/or services of the merchants). Further, the training dataset may comprise data obtained from other sources including third-party data providers, analytics providers, merchant-provided information indicating the way in which incoming charges from those merchants may be structured.

In step 912, a transaction identification model (e.g., a machine learning model similar to the machine learning model 127 described in FIG. 1) may analyze the training dataset. Based on the analysis of the training dataset, the transaction identification model may generate predicted probabilities that incoming charges are preauthorized recurring transactions in step 914.

In step 916, the predicted probabilities generated in step 914 may be validated against ground truth output that indicates which of the incoming charges within the training dataset in step 916 are preauthorized recurring transactions and which of the incoming charges are not preauthorized recurring transactions. The transaction identification model may then use the validations to improve the performance of the transaction identification model by iteratively cycling through the steps of analysis, prediction, and validation until the transaction identification model is configured and/or trained to accurately determine the probability that an incoming charge is a preauthorized recurring transaction identification in step 918.

After being configured for use, in step 918, the transaction identification model may analyze transaction data and determine the probability that an incoming charge is a preauthorized recurring transaction in step 920. At this point, the transaction identification model may be used as described herein.

Further, after performance of step 918, the transaction identification model may be updated over time with an additional transaction dataset in step 922. In step 922, the transaction identification model may receive new datasets and iterate through the process previously described in steps 912-918. The new datasets may comprise additional sets of incoming charges, merchant identifiers, CVVs, merchant category codes, transaction descriptions, amounts of incoming charges, and/or other information that may be used to determine the probability that an incoming charge for a merchant is a preauthorized recurring transaction. The training dataset may be obtained from third parties or compiled based on a plurality of transaction data as described in step 910. After completing training of the transaction identification model in steps 912-918 using the additional transaction data from step 922, the transaction identification model may, in accordance with the embodiments described herein, be used to determine the probability that an incoming charge is a preauthorized recurring transaction as described in step 920.

It will be appreciated that some of the above aspects may be applicable to a scenario in which a merchant is not listed on a blocked merchants list or a blocked merchants list is not available for use in the determination of whether the merchant is on the blocked merchants list. In such cases, a method may comprise receiving transaction data comprising transaction details for an incoming charge associated with a merchant. The merchant may be determined to be included in a blocked merchants list and authorization of incoming charges for preauthorized recurring transactions associated with the merchant may be blocked. Further, based on a machine learning model and the transaction data, a probability that the incoming charge for the merchant is a preauthorized recurring transaction may be determined. The machine learning model may be configured to identify preauthorized recurring transactions based on the transaction data. Based on the probability not exceeding a threshold probability, the authorization of the incoming charge may be prevented from being blocked.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. The steps of the methods described herein are described as being performed in a particular order for the purposes of discussion. A person having ordinary skill in the art will understand that the steps of any methods discussed herein may be performed in any order and that any of the steps may be omitted, combined, and/or expanded without deviating from the scope of the present disclosure. Furthermore, the methods described herein may be performed and/or implemented using any manner of device, system, apparatus, and/or non-transitory computer readable media including the computing devices, computing systems, computing apparatuses, and/or non-transitory computer readable media that are described herein.

What is claimed is:

1. A computer implemented method comprising:
receiving, by a computing device, transaction data comprising transaction details for an incoming charge associated with a merchant;
determining, based on the merchant being included in a blocked merchants list, that authorization of incoming charges for preauthorized recurring transactions associated with the merchant are blocked;
determining, based on a machine learning model and the transaction data, a probability that the incoming charge for the merchant is a preauthorized recurring transaction, wherein the machine learning model is configured to identify preauthorized recurring transactions based on the transaction data; and
based on the probability not exceeding a threshold probability, preventing the authorization of the incoming charge from being blocked.

2. The method of claim 1, wherein the transaction data comprises a card verification value (CVV) field, and wherein the machine learning model is further configured to perform steps comprising:
determining, based on the CVV field, that the probability of the incoming charge being based on a preauthorized recurring transaction is negatively correlated with the CVV field indicating that the incoming charge is based on a card present transaction.

3. The method of claim 1, wherein the transaction data comprises a payment mechanism field, and wherein the machine learning model is further configured to perform steps comprising:
determining, based on the payment mechanism field, that the probability of the incoming charge being based on a preauthorized recurring transaction is negatively correlated with the payment mechanism field indicating that the incoming charge is based on a credit card transaction using a credit card reader device or a mobile wallet transaction using a mobile device and a contactless point of sale system.

4. The method of claim 1, wherein the transaction data comprises a merchant category code field, and wherein the machine learning model is further configured to perform steps comprising:
determining, based on the merchant category code field, that the probability of the incoming charge being based on a preauthorized recurring transaction is positively correlated with the merchant category code field indicating that a category of goods or services provided by the merchant correspond to a preauthorized recurring transaction.

5. The method of claim 1, wherein the transaction data comprises a recurring transaction field, and wherein the machine learning model is further configured to perform steps comprising:
determining, based on the recurring transaction field, that the probability of the incoming charge being based on a preauthorized recurring transaction is positively correlated with the recurring transaction field indicating that the incoming charge is a preauthorized recurring transaction.

6. The method of claim 1, wherein the transaction data comprises a transaction description field, and wherein the machine learning model is further configured to perform steps comprising:
determining, based on the transaction description field, that the probability of the incoming charge being based on a preauthorized recurring transaction is positively correlated with one or more key words describing the incoming charge as a preauthorized recurring transaction.

7. The method of claim 1, wherein the transaction data comprises an amount of the incoming charge, and wherein the machine learning model is further configured to perform steps comprising:
determining that the probability of the incoming charge being based on a preauthorized recurring transaction is positively correlated with a monetary amount of the transaction matching a subscription cost of the merchant.

8. The method of claim 1, further comprising training the machine learning model based on steps comprising:
inputting historical transaction data into the machine learning model, wherein the historical transaction data comprises historical incoming charges of a plurality of merchants;
generating, based on the machine learning model and the historical transaction data, output comprising predicted probabilities that the historical incoming charges are preauthorized recurring transactions; and
adjusting a weighting of parameters of the machine learning model based on an accuracy of the predicted probabilities.

9. The method of claim 8, wherein the historical transaction data comprises at least one of an amount of time between historical preauthorized recurring transactions, one or more dates on which the historical preauthorized recurring transactions were posted, or one or more monetary amounts of the historical preauthorized recurring transaction.

10. The method of claim 1, wherein the historical incoming charges are associated with ground truth labels indicating whether each of the historical incoming charges is either a preauthorized recurring transaction or not a preauthorized recurring transaction.

11. The method of claim 10, wherein the accuracy of the predicted probabilities is based on an extent to which the predicted probabilities correspond to the ground truth labels.

12. The method of claim 1, wherein the preauthorized recurring transactions comprise online service subscriptions, product delivery subscriptions, or news media subscriptions.

13. The method of claim 1, further comprising:
receiving user feedback with respect to an accuracy with which the machine learning model identifies preauthorized recurring transactions; and
adjusting the threshold probability based on the user feedback.

14. The method of claim 1, further comprising:
based on the probability not exceeding a threshold probability, sending a notification to a user, wherein the notification indicates that authorization of the incoming charge is not being blocked.

15. The method of claim 1, further comprising:
based on the probability not exceeding a threshold probability, updating the transaction data to indicate that the incoming charge is not a preauthorized recurring transaction.

16. The method of claim 1, further comprising:
scraping one or more websites associated with the merchant for content comprising one or more key words associated with preauthorized recurring transactions; and
training, based on the content comprising the one or more key words, the machine learning model.

17. The method of claim 16, further comprising:
determining the one or more websites to scrape based on a browser extension configured to detect the one or more key words.

18. The method of claim 16, wherein the content comprises one or more transaction amounts associated with preauthorized recurring transactions.

19. A computing device, comprising:
one or more processors; and
memory storing instructions that, when executed by the one or more processors, cause the computing device to:
receive transaction data comprising transaction details for an incoming charge associated with a merchant;
determine, based on the merchant being included in a blocked merchants list, that authorization of incoming charges for preauthorized recurring transactions associated with the merchant are blocked;
determine, based on a machine learning model and the transaction data, a probability that the incoming charge for the merchant is a preauthorized recurring transaction, wherein the machine learning model is configured to identify preauthorized recurring transactions based on the transaction data; and
based on the probability not exceeding a threshold probability, prevent the authorization of the incoming charge from being blocked.

20. A non-transitory machine-readable medium storing instructions that, when executed by one or more processors, cause the one or more processors to perform steps comprising:
receiving transaction data comprising transaction details for an incoming charge associated with a merchant;
determining, based on the merchant being included in a blocked merchants list, that authorization of incoming charges for preauthorized recurring transactions associated with the merchant are blocked;
determining, based on a machine learning model and the transaction data, a probability that the incoming charge for the merchant is a preauthorized recurring transaction, wherein the machine learning model is configured to identify preauthorized recurring transactions based on the transaction data; and
based on the probability not exceeding a threshold probability, preventing the authorization of the incoming charge from being blocked.
